(19) United States
(12) Patent Application Publication
(10) Pub. No.: US 2010/0124991 A1
(43) Pub. Date: May 20, 2010

(54) GAME AND MARKET MECHANISMS FOR VIRTUAL REAL ESTATE

(75) Inventors: Joseph O'Sullivan, Sunnyvale, CA (US); Ronald Martinez, San Francisco, CA (US); Christopher T. Paretti, San Francisco, CA (US); Marc Eliot Davis, San Francisco, CA (US); Chris W. Higgins, Portland, OR (US); Athellina Athsani, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 12/273,488

(22) Filed: Nov. 18, 2008

(51) Int. Cl. A63F 9/24; G06Q 30/00

(52) U.S. Cl. 463/42; 705/14.27; 705/14.58

(57) ABSTRACT

A content development engine which may collect, organize and distribute multimedia content and metadata associated with specific places, events and people. The CDE may be used with a game mechanic or a revenue-sharing network which may create incentives for users to contribute images, video clips, audio clips, tags, reviews or other multimedia content. When the CDE runs with a game mechanic, users may be rewarded with on-network credits, game points, “ownership” of territories on the map or reputation, and the network credits and game points may be redeemed for, e.g., cash, products, services or frequent flyer miles. When the CDE is coupled to a revenue-sharing network or an advertising engine, users may be compensated for satisfying user generated content (UGC) requests. The compensation may be monetary or non-monetary.

### BACKGROUND

1. Field of the Invention

The present invention relates generally to Content Development Engines (CDE), and more particularly to a method and system for encouraging users to contribute multimedia content and metadata related to people, places, things, businesses, neighborhoods, territories, events or other geographic-related objects or areas.

2. Description of Related Art

Currently available geo-coded content is limited and not evenly distributed such that some places have more content than others, while still other existing geo-coded content is too old and does not accurately represent the actual current conditions of the place or its associated users and events. Furthermore, no way exists for a business owner, advertiser, user or other requesting entity to actively request a specific type of content be generated in association with their location, nor do any means exist to incentivize users to create such content or to reward users for content generated in response to such requests.

### BRIEF DESCRIPTION OF THE DRAWING FIGURES

Embodiments of the present invention are described herein with reference to the accompanying drawings, similar reference numbers being used to indicate functionally similar elements.

FIG. 1 illustrates a system for collecting geographic related content and metadata according to one embodiment of the present invention.

FIGS. 2A to 2D illustrate models for obtaining “ownership” of a territory according to one embodiment of the present invention.

FIGS. 3A and 3B illustrate screenshots of a game when a number of users claim territories on a map according to one embodiment of the present invention.

FIG. 4 illustrates changes of game point value over time according to one embodiment of the present invention.

FIG. 5 illustrates a flow chart of a method for generating a web based imagery map by collected user contributed content according to one embodiment of the present invention.

### DETAILED DESCRIPTION

The present invention provides a content development engine which may collect, organize and distribute multimedia content and metadata associated with specific places, events and people. The CDE may be used with a game mechanic or a revenue-sharing network which may create incentives for users to contribute images, video clips, audio clips, tags, reviews or other multimedia content. When the CDE runs with a game mechanic, users may be rewarded with on-network credits, game points, “ownership” of territories on the map or reputation, and the network credits and game points may be redeemed for, e.g., cash, products, services or frequent flyer miles. When the CDE is coupled to a revenue-sharing network or an advertising engine, users may be compensated for satisfying user generated content (UGC) requests. The compensation may be monetary or non-monetary.

In one embodiment, a game mechanic may be created with the CDE and may be used to compile a digital capture of a map of a certain geographic area through user generated content (UGC). A content generation requester may initiate a game and create a series of incentives to encourage participation from users for the creation and maintenance of content represented on a map. The content generation requester may be an advertiser which uses a game for marketing and encourages users to contribute content relevant to its locations, products or services. Alternatively, the content generation requester may be a business owner, a publisher, a private association (e.g., a neighborhood watch), a public association (e.g., local, state, federal, administration or judicial), or a user.

Almost an infinite number of games may be played with the game mechanic. In one embodiment, a variety of layers of value may be built on top of each other. The first layer may be a map with various beacons, including cell phone base stations (or cell towers), Wi-Fi routers, or fixed Bluetooth™ devices. A game in the first layer may be, e.g., locating cell towers in San Francisco, and a user who is the first one to locate a cell tower may claim the “ownership” of the territory covered by the cell tower. Alternatively, the territory may be a room, a building, a block, a neighborhood, a zip code, or an area code. A second layer may be a layer of metadata or tags which may include tags, search inquiries, ratings and advertisements. A game in the second layer may be, e.g., finding sushi restaurants in San Francisco, and a user may get game points by locating a sushi restaurant and marking it in real-time and real-space with metadata and/or content related to the location which content and metadata is thereafter represented on the map of San Francisco. A third layer may be a media layer, and the media may be text, photographs, audios clips, video clips or sensor signals. A user may get game points by uploading exterior or indoor pictures of a restaurant, its menu, and his comments on the service or food of the restaurant. The owner of the game mechanic may get the rights to display the content contributed by users, and the users may receive payments from content generation requesters for playing the game itself or only upon the production of a response to the request that is satisfactory to the requesting entity. For example, an advertiser may request multimedia content of users enjoying their product with friends, and as such, multimedia content that is offensive or derisive of the product would not be satisfactory and therefore subject to not being posted and not triggering any compensation to the user. In fact, in most embodiments, users reputation and continued ability to participate in the system's various games will be directly impacted with their track record at producing satisfactory or improper content and metadata.

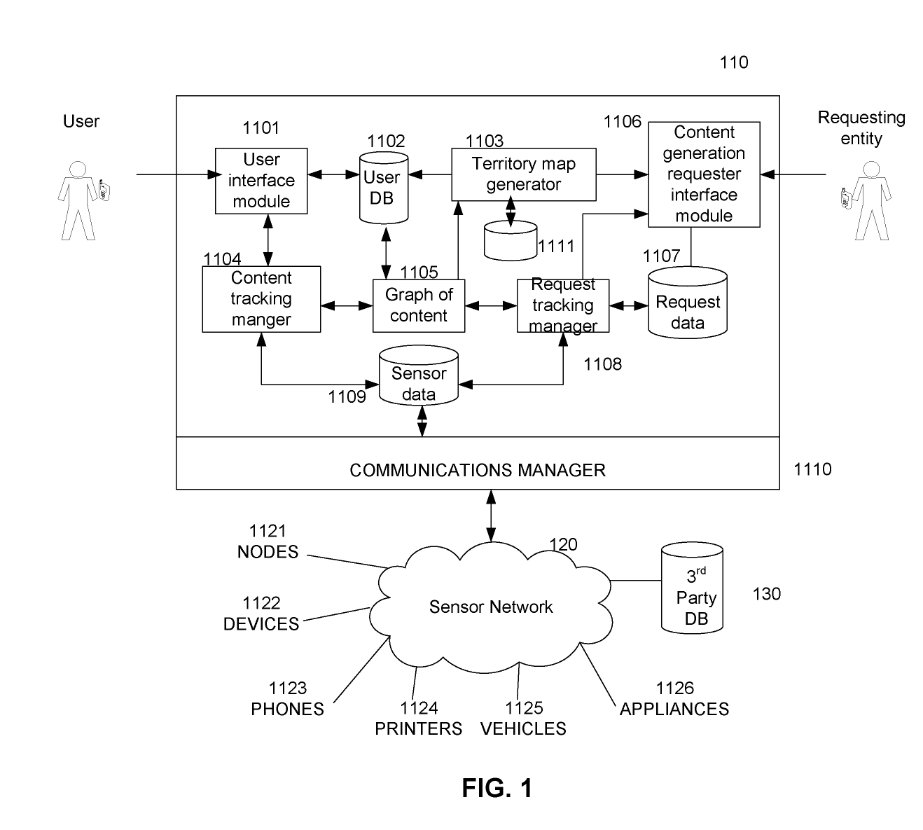

FIG. 1 illustrates a system for collecting geography related data according to one embodiment of the present invention. As shown, the system may have a content development engine 110 coupled to a sensor network 120. The content development engine 110 may have a user interface module 1101, a user database 1102, a territory map generator 1103, a content tracking manager 1104, a content graph 1105, a content generation requester interface module 1106, a request database 1107, a request tracking manager 1108, a sensor database 1109, a communications manager 1110, and a game map database 1111. The content development engine 110 may create an aggregated centralized graph of content and meta-data associated with real-world locations or entities, and may use the content and meta-data to populate a user-centric “territory map” as a part of an incentive system for gaining user participation to generate or update content or tags.

The user interface module 1101 may receive user input. A user may sign up to become a registered user of the system by providing his registration information, e.g., his ID, password and icon. A user's ID may be used by the system to identify him and may be, e.g., his mobile phone number. The user registration information may include information about a user's telecommunication service carrier and the user's permission to get his information from the carrier. The user may contribute content to the system via the user interface module 1101. The user interface module 1101 may also include a publicly-available website for non-registered or anonymous users to view public game maps and statistics or other data associated with game playing users, content and metadata responses, requests, requesting entities, games and campaigns in real-time and over time. The publicly-available website may be coupled to the game map database 1111. [Maps database 110?? would also be attached to this publicly-facing resource aspect of 1101]

The user registration information and the user's game records may be stored in a user database 1102. A user may update his registration information in the database 1102 through the user interface module 1101. The user's game record may include, e.g., games played, territories claimed, tags added, content contributed, game value received, and rankings or reputation scores. Other relevant data will be apparent to skilled people in the field.

A content tracking manager 1104 may receive user contributed content via the user interface module 1101, and may map all content for a specific place or region in real space or time and make it available to the graph of content 1105. Over time, the aggregated content and/or metadata may be organized into a graph of content coded with its content object, type, creating users, subject users, subject locations, time and related content generation requests, satisfaction scores and continued interaction logs once created. In one embodiment, the graph of content or the territory map generated and maintained by the system may be dialed back to represent the conditions at any specific place and time as well as any combination of requests, games or campaigns over time. The content tracking manager 1104 may also decide “ownership” of virtual real estate or properties. In one embodiment, when multiple users claim the ownership of one property, the content tracking manager 1104 may give the “ownership” to the first claimant. Alternatively, it may give ownership to the claimant with the highest satisfaction score, the claimant with the most content or metadata generated, the claimant with the most recent metadata or any other requesting entity or network defined criteria. If a requesting entity can describe the conditions for ownership, and the sensor network can test for those conditions, then any set or combination may be used to define specific prerequisites to territory ownership for that request, game or campaign.

A content generation requester interface module 1106 may receive requests from content requesters. A content generation requester may use a game to advertise its brand, may want to motivate as many users as possible to play the game, and thus may provide incentives like gift cards, coupons, game points or frequent flyer miles. For example, a content generation requester may initiate a game to find Starbucks™ stores in San Diego, find Shell™ gas stations in Los Angeles, or find book stores in San Francisco. Together with a content generation request, a content generation requester may also need to provide data to specify basic information about a game, e.g., the territory the game will be played in, the game board, the rules of the game, the start time, and the reward mechanism. The content generation request data may be stored in a request database 1107. Content generation requesters may manage their requests, games and campaigns in real-time or over time via the content generation requester interface module 1106.

A request tracking manager 1108 may receive, map and make known all explicit or implicit requests for user generated content or metadata associated with a real-world entity. Requests may be mapped together with the user generated content, so as to create a centralized view of what exists and what is requested in order to prioritize territories or types of content or metadata to be to communicated to users. The request tracking manager 1108 may also determine whether a game request is accepted and when a requested game can start. The request tracking manager 1108 may turn down a game request if a similar game has been played recently. For example, if a game for finding book stores in San Francisco was played recently, a game request for finding book stores in the Sunset District in San Francisco may be turned down. The request tracking manager 1108 may sort game requests based on the time they are received, or territories they are going to be played in. In one embodiment, the request tracking manager 1107 may limit the number of games being played simultaneously. If too many game requests related to one territory are received during a short period of time, the request tracking manager 1108 may delay the start time of some of the games to avoid dispersion of users' attention.

The content development engine 110 may be coupled to a sensor network 120 via a communication manager 1110. The sensor network 120 may receive sensor data from various electronic devices including, e.g., network nodes 1121, Wi-Fi devices 1122, phones 1123, printers 1124, vehicles 1125 and appliances 1126. The sensor network 120 may also be coupled to third party databases to receive sensor data. A third party may be, e.g., mobile phone service carriers or ISPs. The sensor data may be, e.g., emails, text messages, positioning signals, Internet browsing activities, credit card transaction histories or Instant Messages (IM), and may be stored in a sensor database 1109. The content tracking manager 1104 or the request tracking manager 1108 may analyze the sensor data and obtain live W4 information about what is going on with a user, e.g., who he is, where he is, what he is doing and when he is doing that. Such information may be used by the content tracking manager 1104 as supporting evidence when deciding whether to accept content contributed by a user. In one embodiment, a user may ask permission to upload some negative comments about a hotel. If the content tracking manager 1104 finds out that the user has never been to that hotel, it may reject the user's contribution.

The graph of content 1105 may use sensor data along with the user contributed content from the content tracking manager 1104 and content generation requests from the request tracking manager 1108 to apply a game or revenue sharing logic to organize users' contributions and communicate objectives and rewards to them including the publication of a real-time territory map displaying first ranked users overlaid on the map. The territory map may be constantly updated, together with incentives the users got and/or the users' rankings, in response to new user input or sensor data or third party data.

The territory map generator 1103 may receive the graph of content 1105, and may generate a territory map with the content integrated with a map of a territory as well as a game map representing one or more requests and their related locations, current ownership status and user data if owned. The territory map may be provided to a user via the user interface module 1101 as well as a publicly-available website and to a content generation requester via the content generation requester interface module 1106. In one embodiment, the territory map may be an imagery map of a couple of blocks in a city with the street names marked. The name of the “owner” of this territory and the time he successfully claimed the “ownership” may be displayed as well as more information about the user, their territories and historical participation rankings as well as current rank and level for a specific request, game or campaign. At the location of a sushi restaurant, there may be several tags, e.g., restaurant, Asian food, sushi, and the restaurant's name. Names of the tag creators and time for tagging may be displayed together with the tags. If a user clicks on the restaurant's name, media about the restaurant may be displayed, which may include: exterior and internal pictures of the restaurant, a copy of its menu, video clips of the food, and some consumer reviews. Users may look at and update the tags and media at any time.

The game map database 1111 may store existing and past game maps and may be accessed by the territory map generator 1103.

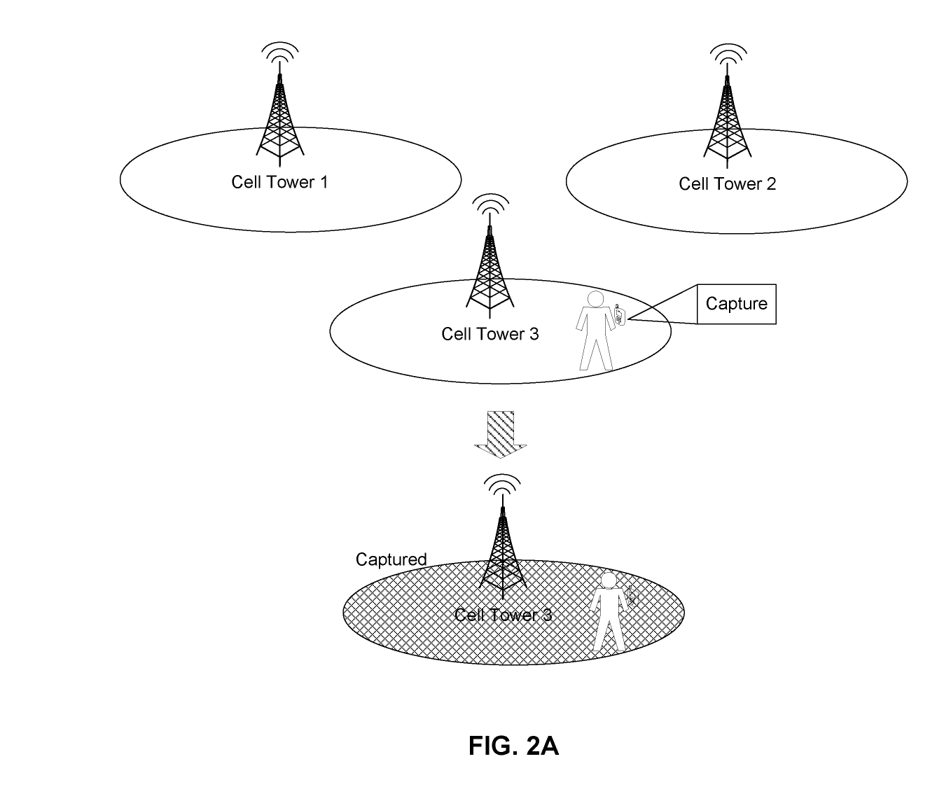

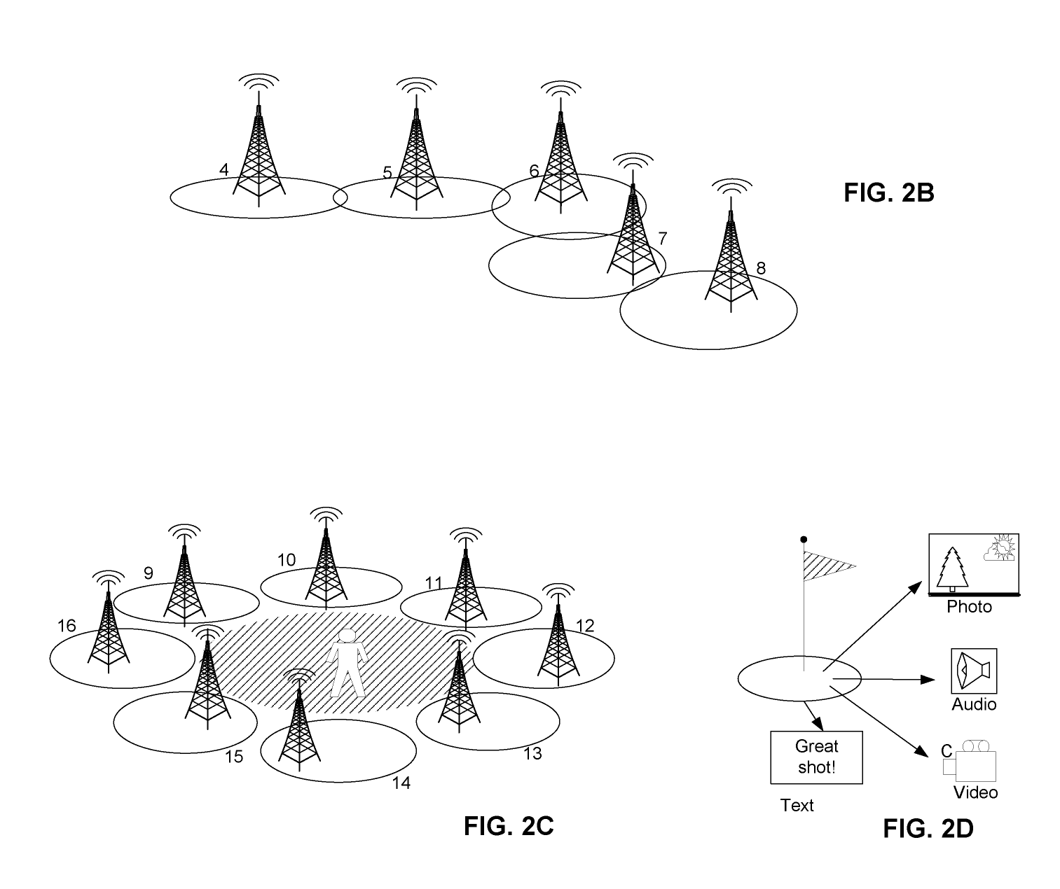

FIGS. 2A to 2D illustrate methods for obtaining “ownership” of a territory according to one embodiment of the present invention. A series of game dynamics and market mechanisms may be used to encourage users to perform certain actions in the physical world that will add value to a territory map. In one embodiment, a user may get the “ownership” of a territory by establishing physical presence in the territory. In one embodiment, a user may claim a territory by locating a beacon in it. The beacon may be a cell tower, a Wi-Fi router, or a fixed Bluetooth™ device. A Cell Rush game may be used to locate the beacons. For example, a content generation requester may want to locate cell towers in San Francisco, and may initiate a Cell Rush game which rewards a user “ownership” of a territory if he is the first one to locate a cell tower in San Francisco. A user A may take his mobile phone and a positioning device, e.g., a GPS receiver, to move around in the city of San Francisco. As shown in FIG. 2A, the user may be in a part of San Francisco covered by cell towers 1, 2, and 3. When he is close to a cell tower, e.g., the cell tower 3, his mobile phone may receive the ID of the cell tower. He may use his GPS receiver to determine his location, which is roughly the cell tower's location, and may log into the game, report the ID of the cell tower, report the location and claim the “ownership” of the cell as his territory. If the user is the first one claiming the territory, he may “own” that territory, as a piece of virtual real estate. As a result, the cell tower may be added to the map of San Francisco, together with the icon of the user A and the time the user A successfully claimed the territory. Since the mobile phone network covering San Francisco is constituted by a number of cell stations, the Cell Rush game may divide the city into a number of territories, each of which is covered by a cell tower, and may relate the territories, or virtual real estate, to their real-world locations. Layers of additional types of value may be added to the territories, as described below.

Similarly, locations of Wi-Fi routers and fixed Bluetooth™ devices in a certain geographic area may be located and be added to the map of that geographic area as landmarks of virtual real estate.

In one embodiment, a user may use an electronic device which may sense a beacon's ID and geographically locate itself. At one location, the device may sense a unique ID of a WiFi router, a cell tower, a Bluetooth™ device, or other beacons, e.g., an object with an RF ID, determine the signal strength of the beacon ID, determine its location and correlate the beacon ID to its location. The device may establish the beacon's location by correlating readings at multiple locations.

A user may claim an area around a beacon as his territory when he locates that beacon. In one embodiment, a user may get priority over certain territories by staking a particular shape around the territory. In one embodiment, a user may link or chain a number of territories together to create a form or shape. The territories may be linked to each other either diagonally, or horizontally, or vertically, etc. As shown in FIG. 2B, a user may have located a chain of cell towers 4-8, and may claim territory chaining these cell towers. In FIG. 2C, a user may have located adjacent cell towers 9-16 which form a circle. In addition to claiming the area covered by each of the beacons, the user may also claim an inner territory within the circle.

In one embodiment, a user may annotate a claimed virtual property with personalized icons. In the embodiment shown in FIG. 2D, by configuring his registration information, an “owner” may add a flag to the territory he successfully claimed. The “owner” may also add text, photos, audio clips or video clips to mark his territory.

The system may establish geographic related territories and zones in which beacon or territory may be sensed. In one embodiment, a user may get an email or SMS (short message service) notification if the user is encroaching in someone else's territory, so that he does not waste time on territories already claimed. The system may also establish minimum actions, e.g. the amount, type or quality of new content or metadata generation required for one user to “conquer” an already claimed territory and take it away from the current “owner.” The game map may include a display mode for representing those actions within their respective territories so that a user can investigate and plan how to gain more territories as well as how to defend already owned territories from new “attacks.”

In one embodiment, the game may have a decay function and an “owner” may lose his territory if he does not come back to it during specific intervals. In one embodiment, a user may have to meet certain conditions to claim or keep “ownership” of a territory. The conditions may be, e.g., a certain time period, a regularity of new or updated content or metadata being generated over time, a related user response rate to content, popularity of content or other request satisfaction conditions specified by the requesting entity.

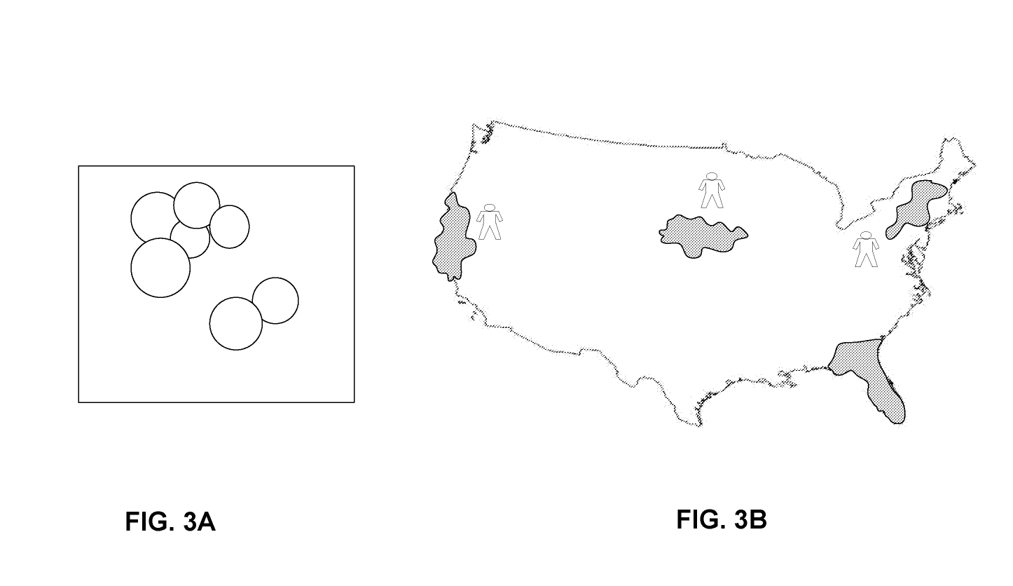

FIGS. 3A and 3B illustrate screenshots of a game when a number of users claim territories on a map according to one embodiment of the present invention. New claims may be displayed on the map in real time as users play. In one embodiment, when a user locates a beacon and claims territory around the beacon, that territory may be highlighted on the map. In one embodiment, a dynamic heat map of interest may be generated according to the number of claims, as shown in FIGS. 3A and 3B. The more claims in an area, the more highlighted territories in that area. The content generation requesters and users may determine the popularity of the territories with the heat map.

In addition to claiming the “ownership” of a territory by establishing physical presence at a location, a user may own a tag by first adding the tag to a territory and may gain game points based on the tag's usage. A tag may be metadata about a location, a type of event occurring at the location (e.g., “football”), a type of people who frequent the location (e.g., “bankers”), etc. The tag may be geographic based, social based, or event related. The tag may also be search-query-type.

If a content generation requester starts a game relevant to a tag, the owner of the tag may get game points for that. For example, if a user tags a territory in San Francisco with the word “rose,” and a content generation requester initiates a game for finding flower stores in San Francisco sometime later, the owner of the tag “rose” may gain game points. If a user adds a tag to another user's territory, the owner of the territory may get game points as well.

Since only the user who is the first one to add the tag will get game points, users may predict tags relevant to a territory that content generation requesters or other users may find useful in the future, and may choose tags with higher predictive values. For example, there is a flower store on a territory and a user may predict that the word “rose” may become very popular before the Valentine's Day and may tag that property with the word “rose.” The user may get game points if content generation requesters initiate games related to “rose.”

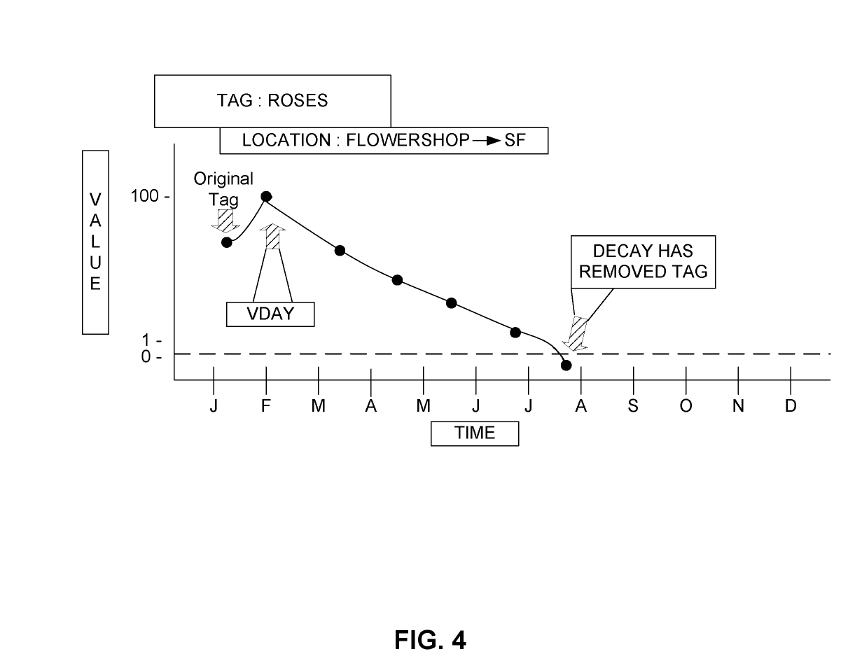

In one embodiment, the value of a tag may be set to go negative to fight spamming. For example, the tag “rose” will become popular before Valentine's Day. As a game strategy, users may lay down the tag “rose” at all places and all times and wait for the Valentine's Day to get game points. This may jam the system. To prevent this from happening, game point values may be set to decay over time. As shown in FIG. 4, the game point value for the tag “rose” may be close to 100 before the Valentine's Day, and may decline over time and even may become negative in, for example, summertime. Thus, the more “rose” tags a user lays, the more negative points he may get. This may encourage players to lay tags when a tag is at its peak value and reduce spamming.

Incentives may be provided to encourage users to upload media related to a location in an area to populate the map of the area. The media may be, e.g., detailed information about the location; photos or video clips of the location from different angles or at different positions or distances; photos or video clips of the location at different times of a day or month or season, in different weather conditions, or during different events; different sounds from a location at different times of a day or month or season, in different weather conditions, or during different events; 3D models; blueprints; x-rays; and 360 degree surface views.

In one embodiment, the request tracking manager 1108 may determine what is in high demand and give higher game points to users who contributed the content in high demand first.

The system may provide a mechanism to encourage players to contribute useful content. The system may keep a record of how other players interact with the content a user contributed. In one embodiment, the more people look at the content, the more games points the content contributor can get. In one embodiment, the system may allow users to rate how useful the content is. The more the people think it is useful, the more game points the content contributor may get.

In one embodiment, game points a user gets may be based on the relevance of the content he contributed. For example, at the location of a sushi restaurant, a user B uploaded a sushi recipe, and a user C uploaded a menu of the restaurant. If other users think that the menu is more relevant, the user C may get higher number of game points.

In one embodiment, game points a user gets may be based on the popularity of the content he contributed. A user may lose game points for adding erroneous or esoteric content. A tag or media that is not reinforced by other users or content generation requester may decay to the point of removal from the system.

In one embodiment, the system may determine or compute territory or tag value in advance by getting feedback from sources such as popular social sites www.flickr.com or www.facebook.com. The more popular the content is, the higher value it may be assigned.

The system may provide a mechanism to allow users to trade properties to redeem the incentives. In one example, one user may have successfully claimed some properties, but he is more interested in frequent flyer miles. If the user can find a second user who has received frequent flyer miles but is more interested in ownership of territories, he may trade his territories to the second user for the frequent flyer miles.

In addition to mobile devices, a user may add tags, upload media or trade properties via fixed electronic devices, e.g., a desktop computer or a set-top box.

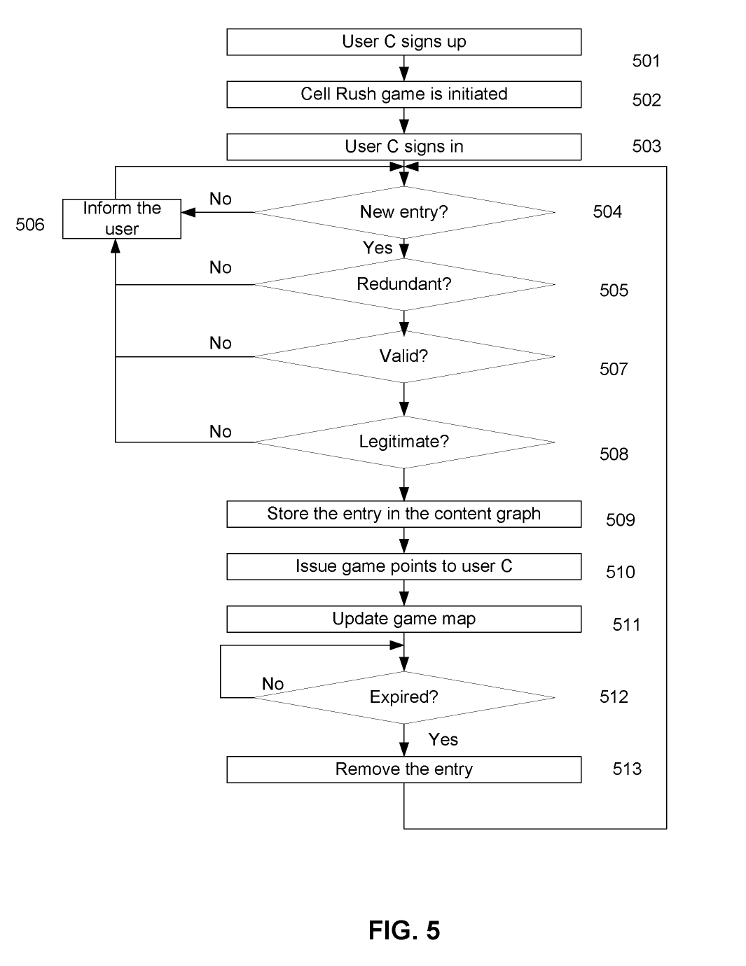

FIG. 5 illustrates a flow chart of a method for generating a web based imagery map by collecting user contributed content according to one embodiment of the present invention.

At 501, a user C may sign up to become a registered user of the system shown in FIG. 1. The user may set his user name, password and icon via the user interface module 1101. The user may also customize his profile. The users' profile data may be stored in the user database 1102

At 502, a content generation requestor may initiate a Cell Rush game, providing incentives for users to contribute content about San Francisco. The content generation requester may input basic game information via the content generation requester interface module 1106. The game information may be, e.g., the territory the game will be played in, the game board, the rules of the game, the start time, and the reward mechanism. The content generation request data may be stored in the request database 1107.

At 503, a user may login and start to play the Cell Rush game. The game board may be displayed on the user's device, e.g., a mobile phone, a portable computer, a desktop computer, a media player, a set-top box, or other electronic device having access to the Internet. The game board may include the current territory map and the user's profile, e.g., his icon, current game points and rank.

At 504, the content tracking manager 1104 may receive an entry from the user C.

At 505, the content tracking manager 1104 may check the graph of content 1105 to decide whether the entry is a redundant entry. A comparison algorithm or a media recognition software may be used to make the decision. If it is a redundant entry, the user may be informed at 506 and the process may return to 504. In one embodiment, the content tracking manager 1104 may make recommendations for other possible entries, e.g., a territory or tag that has not been claimed.

If the entry can pass the redundancy check, at 507, the content tracking manager 1104 may check the validity of the entry, e.g., by using a right management tool such as Creative Commons™ to make sure that there are no copyright issues. If the validity check fails, the process may return to 506.

If the entry can pass the validity check, at 508, the content tracking manager 1104 may check the legitimacy of the entry to make sure that, e.g., it is a real effort and it meets the requirements of the content generation request. In one embodiment, a user may need to enter compulsory data, such as testimonials from bystanders, to show evidence of his claim to a territory. If the legitimacy check fails, the process may return to 506.

If the entry can pass the legitimacy check, the content tracking manager 1104 may accept the entry and store it into the graph of content 1105 at 509. In addition to the entry, the time the entry was accepted and the user C's ID may be added to the graph of content as well.

As 510, the request tracking manager 1108 may issue game points to the user C, and the user database 1102 may be updated to include such information.

At 511, the game map may be updated. If the entry is to claim “ownership” of a territory, the territory may be highlighted and the user's icon may be displayed. If the entry is a tag, it may be displayed on the game map. If the entry is a multimedia document, e.g., a video clip of a restaurant, its name may be added to a list of multimedia documents about the restaurant, and may be displayed when the tag of the restaurant is clicked on. At the same time, the user C's game points may be updated and displayed.

At 512, a countdown may be started toward an expiration time of the user's ownership or a tag. The user may renew his stake by, e.g., going back to the territory, or may let his stake expire.

At 513, the expired stake may be removed and the process may return to 504.

FIG. 5 is only used to illustrate an embodiment of the present invention, instead of limiting the sequence of the steps. For example, 508 may be performed before 507, or various ones of the checks in 504, 505, 507, and 508 may be performed in different orders. Additional steps may be added to the method shown in FIG. 5 as well. In one embodiment, if an entry can pass the legitimacy check at 508, the content tracking manager 1104 may check the value of the entry against the requirements of the content generation request, and may return recommendations for higher value entries.

The CDE may yield a very granular, highly dynamic and accurate map of mobile interest and inventory. The system may maintain a repository of all the beacons or virtual real estate that can be geographically located, all tags used to annotate the beacons or virtual real estate and all UGC media contributed by user.

Thus, instead of collecting data and building up layers of a map by one entity with costly procedures, with the present invention, gaming dynamics and marketing mechanisms may be used to encourage users to contribute and update map data and the cost, if any, will be shared by content generation requesters. Almost unlimited content generation requests may be initiated to request UGC from users, and the territory map may be updated frequently, thus making the map more valuable to users. Also enabled is a collective sophisticated mechanism to reward users.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A content development engine (CDE), comprising:
a content generation requester interface module for receiving information about a content generation request from a requesting entity;
a user interface module for receiving a user response to the content generation request; and
a user database for storing information about the user including incentives the user got as a result for responding to the content generation request,
wherein the content generation request is related to a territory on a map.

2. The CDE of claim 1, further comprising: a graph of content which includes user responses organized by logic of the content generation request.

3. The CDE of claim 2, further comprising: a content tracking manager for determining whether to make a user response available to the graph of content.

4. The CDE of claim 3, wherein the content tracking manager maps the user responses in real space and real time.

5. The CDE of claim 2, further comprising: a request tracking manager for determining whether to make a content generation request available to the graph of content.

6. The CDE of claim 5, wherein the request tracking manager maps the content generation requests in real place and real time.

7. The CDE of claim 6, wherein the request tracking manager determines whether to issue incentives to a user.

8. The CDE of claim 2, further comprising: a communications manager for receiving data from a sensor network.

9. The CDE of claim 8, wherein the communications manager receives data from a third party database.

10. The CDE of claim 2, further comprising: a territory map generator for displaying information from the graph of content relative to the user response.

11. The CDE of claim 2, wherein the user response is selected from a group consisting of: the location of a beacon, a tag and a content object.

12. The CDE of claim 2, wherein value of the response may be set to decay over time.

13. The CDE of claim 1, wherein the requesting entity is an entity selected from a group consisting of: an advertiser, a business owner, a publisher, a private association, a public association and a user.

14. The CDE of claim 1, wherein the territory is selected from a group consisting of: a room, a building, a block, a neighborhood, a zip code, an area code, and a cell tower coverage area.

15. The CDE of claim 11, wherein the content object is selected from a group consisting of text, photographs, audio clips, video clips and sensor signals.

16. A method for publishing a map, comprising:
receiving a content generation request;
receiving a user response to the content generation request; and
compiling a graph of content including user responses organized by logic of the content generation request,
wherein the content generation request is related to a territory on a map.

17. The method of claim 16, further comprising: checking the graph of content to determine whether a response is redundant.

18. The method of claim 16, further comprising: checking validity of a response.

19. The method of claim 16, further comprising: checking legitimacy of a response.

20. The method of claim 16, further comprising: rewarding a user if his response meets requirements of the content generation request.

21. The method of claim 20, wherein the rewarding is based on demand for the response.

22. The method of claim 20, wherein the rewarding is based on popularity of the response.

23. The method of claim 20, wherein the rewarding is based on relevance of the response to the content generation request.

24. The method of claim 16, further comprising: generating a territory map for displaying information from the graph of content on a map.

25. The method of claim 16, further comprising: displaying a game map including the territory map and a user's game record.

26. The method of claim 25, further comprising: updating the game map if a user's response is accepted into the graph of content.

27. The method of claim 16, further comprising: setting an expiration time for a response and deleting the response at the expiration time.

28. The method of claim 16, wherein the response is selected from a group consisting of: the location of a beacon, a tag and a content object.

29. A system for building up a map with user generated content comprising the CDE of claim 1.

30. A computer program product comprising a computer-readable medium having instructions which, when performed by a computer, perform a method for publishing a map, said method comprising:
receiving a content generation request;
receiving a user response to the content generation request; and
compiling a graph of content including user responses organized by logic of the content generation request,
wherein the content generation request is related to a territory on a map.
